(19) United States
(12) Patent Application Publication
(10) Pub. No.: US 2007/0066127 A1
(43) Pub. Date: Mar. 22, 2007

(54) Connector having an actuator which is stably operable

(75) Inventor: Kanji Inoue, Tokyo (JP)

Correspondence Address: WILLIAM COLLARD;COLLARD & ROE, P.C., 1077 NORTHERN BOULEVARD, ROSLYN, NY, 11576, US

(73) Assignee: JAPAN AVIATION ELECTRONICS INDUSTRY, LIMITED, Tokyo (JP)

(21) Appl. No.: 11/523,411

(22) Filed: Sep. 19, 2006

(30) Foreign Application Priority Data
Sep. 20, 2005 (JP) 2005-271993

(51) Int. Cl. H01R 12/24

(52) U.S. Cl. 439/495

(57) ABSTRACT

In a connector including first and second contacts having first and second contact points, respectively, an actuator is provided rotatable between a closed position and an open position and includes a cam portion faced to a connection object and a cutout portion adjacent to the cam portion. The first contact further has an engaging portion and a first beam portion elastically supporting the engaging portion to a housing. The engaging portion has a recess faced to the connection object and engaged with the cam portion. The second contact further has a contacting portion disposed at the cutout portion and a second beam portion elastically supporting the contacting portion to the housing. The contacting portion has a shape such that the contacting portion surrounds the cam portion in cooperation with the recess and biases the actuator towards the open position when the actuator is located near the open position.

This application claims priority to prior Japanese patent application JP 2005-271993, the disclosure of which is incorporated herein by reference.

### BACKGROUND OF THE INVENTION

This invention relates to a connector for connecting a connection object, such as a FPC (Flexible Printed Circuit) or a FFC (Flexible Flat Cable), to a substrate and, in particular, to a connector having a rotary actuator for pressing a connection object to a contact point of a contact.

A connector of the type is disclosed, for example, in Japanese Patent (JP-B) No. 3295808. The connector comprises a housing, a number of first and second contacts fixed to the housing, and an openable/closable actuator having opposite ends rotatably supported by the housing. The actuator has first cam portions and through holes adjacent to the respective first cam portions and corresponding to end portions of the first contacts. The actuator also has second cam portions (cutout portions) corresponding to end portions of the second contacts and a flat portion for pressing a FPC.

In the state where the actuator is opened, the FPC is inserted to the connector. Next, the actuator is rotated around the opposite ends rotatably supported by the housing. Then, the first cam portion presses the FPC. Therefore, a signal pattern of the FPC is connected to the first contacts. Since the second cam portion is pivotally supported by the second contacts, the flat portion of the actuator presses the FPC. Therefore, the signal pattern of the FPC is connected to second contact points of the second contacts.

In the above-mentioned connector, end portions of the second contacts have a simple rounded shape. Therefore, the actuator is not kept in a stable condition either at a closed position or an open position. Further, smooth rotation is difficult to achieve.

### SUMMARY OF THE INVENTION

It is therefore an object of this invention to provide a connector having an actuator which can be kept in a stable condition either at a closed position or an open position.

It is another object of this invention to provide a connector having an actuator which can smoothly be rotated.

Other objects of the present invention will become clear as the description proceeds.

According to an aspect of the present invention, there is provided a connector to be connected to a connection object having first and second surfaces faced to each other in a first direction and inserted in a second direction perpendicular to the first direction, the connector comprising first contact including a first contact point to be contacted with the first surface of the connection object, a second contact including a second contact point to be contacted with the first surface of the connection object, a housing to which the first and the second contacts are fixed, and an actuator faced to the second surface of the connection object and rotatable between a closed position at which the actuator brings the first surface of the connection object into press contact with the first and the second contact points and an open position at which the press contact is released, the actuator including a cam portion faced to the second surface of the connection object and a cutout portion adjacent to the cam portion, the first contact further including an engaging portion with a recess which is faced to the second surface of the connection object and engaged with the cam portion and a first beam portion making the engaging portion be elastically held by the housing, the second contact further including a contacting portion faced to the second surface of the connection object and disposed at the cutout portion and a second beam portion making the contacting portion be elastically held by the housing, the contacting portion having a special shape such that the contacting portion surrounds the cam portion in cooperation with the recess and biases the actuator towards the open position when the actuator is located near the open position.

### BRIEF DESCRIPTION OF THE DRAWING

FIG. 1A is a half-section perspective view of a connector according to an embodiment of this invention;

FIG. 1B is a sectional perspective view taken along a line 1b-1b in FIG. 1A;

FIG. 2 is a sectional perspective view similar to FIG. 1B and showing a state after the connector in FIG. 1A is operated;

FIG. 3 is an enlarged side view of a characteristic part of the connector in FIG. 1A;

FIG. 4A is a sectional view of the connector in FIG. 1A at a section similar to that in FIG. 1A;

FIG. 4B is a sectional view of the connector in FIG. 1A at a section similar to that in FIG. 1B;

FIG. 5A is a sectional view similar to FIG. 4A while the connector in FIG. 1A is operated;

FIG. 5B is a sectional view similar to FIG. 4B while the connector in FIG. 1A is operated;

FIG. 6A is a sectional view similar to FIG. 4A after the connector in FIG. 1A is operated;

FIG. 6B is a sectional view similar to FIG. 4B after the connector in FIG. 1A is operated; and

FIG. 7 is a side view of a modification of the characteristic part in FIG. 3.

### DESCRIPTION OF THE PREFERRED EMBODIMENTS

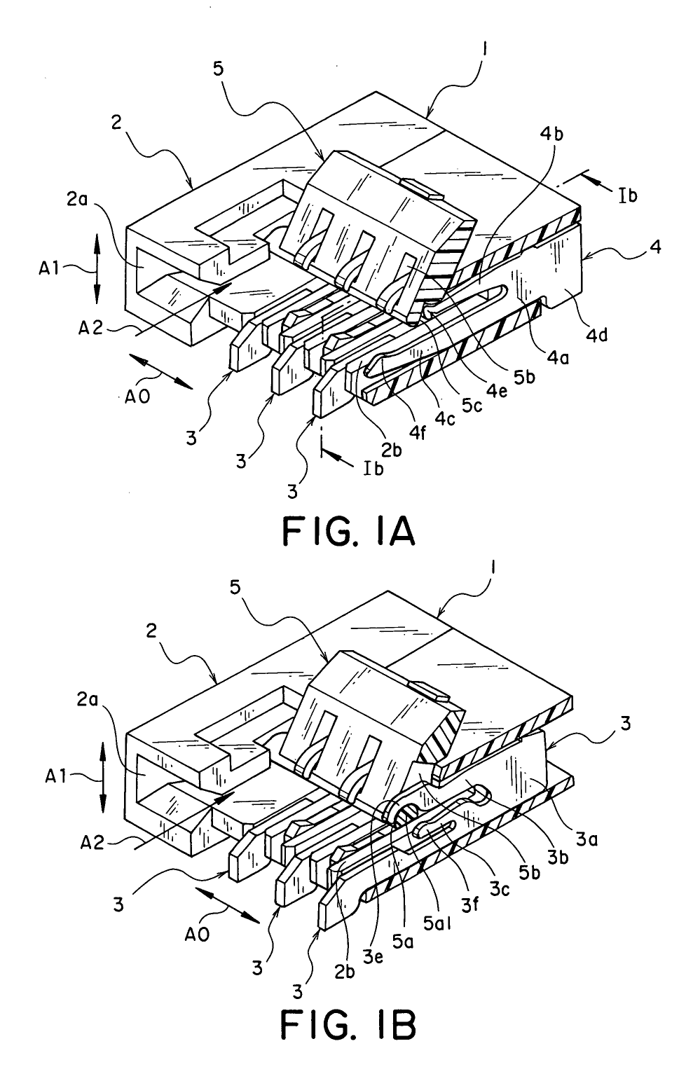

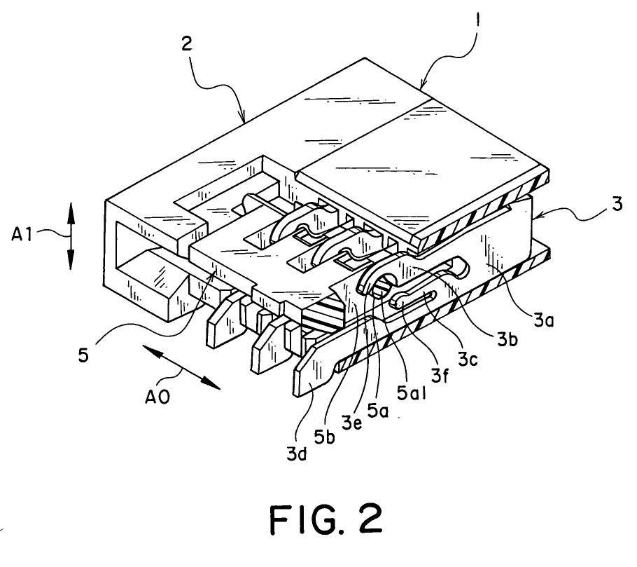

Referring to FIGS. 1A, 1B, and 2, description will be made of a connector according to an embodiment of this invention.

The connector depicted at 1 in the figure is a connector for connecting a connection object, such as a FPC or a FFC having a flat shape and flexibility, to a substrate. For convenience of description, the connection object will hereinafter be called the FPC. The connector 1 comprises an insulating housing 2, a number of conductive first contacts 3 fixed to the housing 2 and disposed at a predetermined pitch in a predetermined direction (transversal direction) A0, a number of conductive second contacts 4 disposed at a preselected pitch between every two adjacent ones of the first contacts 3, and an actuator 5 disposed at a front part of the housing 2 and supported by the first and the second contacts 3 and 4 to be rotatable between an open position illustrated in FIGS. 1A and 1B and a closed position illustrated in FIG. 2 In the following description, a vertical direction, i.e., a thickness direction of the housing 2 will be called a first direction A1 while a direction from front to back of the housing 2 will be called a second direction A2.

Each of the first contacts 3 has a base portion 3a held by the housing 2, and upper and lower beam portions 3b and 3c extending from the base portion 3a and elastically deformable. The upper and the lower beam portions 3b and 3c are faced to each other in the first direction A1 with a space left from each other. The base portion 3a is provided with a terminal portion 3d formed near its front end to be connected to a substrate (not shown). The upper beam portion 3b is provided with an engaging portion 3e formed at its front end and having a recess of a generally U shape in section. The lower beam portion 3c is provided with a first contact point 3f formed near its front end to be electrically connected to the FPC. Thus, the engaging portion 3e and the first contact point 3f are elastically held by the housing 2 via the upper and the lower beam portions 3b and 3c, respectively.

Each of the second contacts 4 has a base portion 4a held by the housing 2, and upper and lower beam portions 4b and 4c extending from the base portion 4a and elastically deformable. The upper and the lower beam portions 4b and 4c are faced to each other in the first direction A1 with a space left from each other. The base portion 4a is provided wit a terminal portion 4d formed near its front end to be connected to the substrate. The upper beam portion 4b is provided with a contacting portion 4e formed at its front end and having a special shape which will later be described in detail. The lower beam portion 4c is provided with a second contact point 4f formed near its front end to be electrically connected to the FPC. Thus, the contacting portion 4e and the second contact point 4f are elastically held by the housing 2 via the upper and the lower beam portions 4b and 4c, respectively. The first contact points 3f and the second contact points 4f are arranged in two rows in the predetermined direction A0 and in a staggered or a zigzag pattern.

The actuator 5 has a plurality of cam portions 5a formed at positions in one-to-one correspondence to the engaging portions 3e of the first contacts 3, and a plurality of through holes 5b adjacent to the cam portions 5b. Each of the cam portions 5a has a shaft portion 5a1 having a generally semicircular section and serving as a rotation shaft of the actuator 5. The recess of the engaging portion 3e has a shape such that the recess is fitted over the shaft portion 5a1 to allow rotation of the shaft portion 5a1. When the actuator 5 is located near the open position, the contacting portion 4e surrounds the cam portion 5a in cooperation with the recess of the engaging portion 3e.

The actuator 5 is provided with a plurality of cutout portions 5c formed on one side of an end portion thereof in one-to-one correspondence to the contacting portions 4b1 of the second contacts 4. Each of the cutout portions 5c has an inner angle of about 90°. Thus, an inner bottom surface of the cutout portion 5c extends over two planes perpendicular to each other. The actuator 5 is provided with a flat portion 5d formed on the other side of the end portion to press the FPC.

The housing 2 has an insertion groove 2a to receive the FPC inserted therein. The insertion groove 2a extends in the predetermined direction A0 and the second direction (front-to-back direction) A2 and has a bottom surface defined by a support wall portion 2b of the housing 2.

In the state where the actuator 5 is at the open position as illustrated in FIGS. 1A and 1B, the FPC is inserted to the insertion groove 2a in the second direction A2. The FPC is supported and guided by the support wall portion 2b and is introduced between the first and the second contact points 3f and 4f and the actuator 5. The first and the second contact points 3f and 4f slightly protrude from the support wall portion 2b towards the insertion groove 2a.

After the FPC is inserted to the insertion groove 2a, the actuator 5 is rotated to the closed position as illustrated in FIG. 2. Then, the FPC is forced by the actuator 5 to be brought into press contact with the first and the second contact points 3f and 4f. As a result, the connector 1 is connected to the FPC.

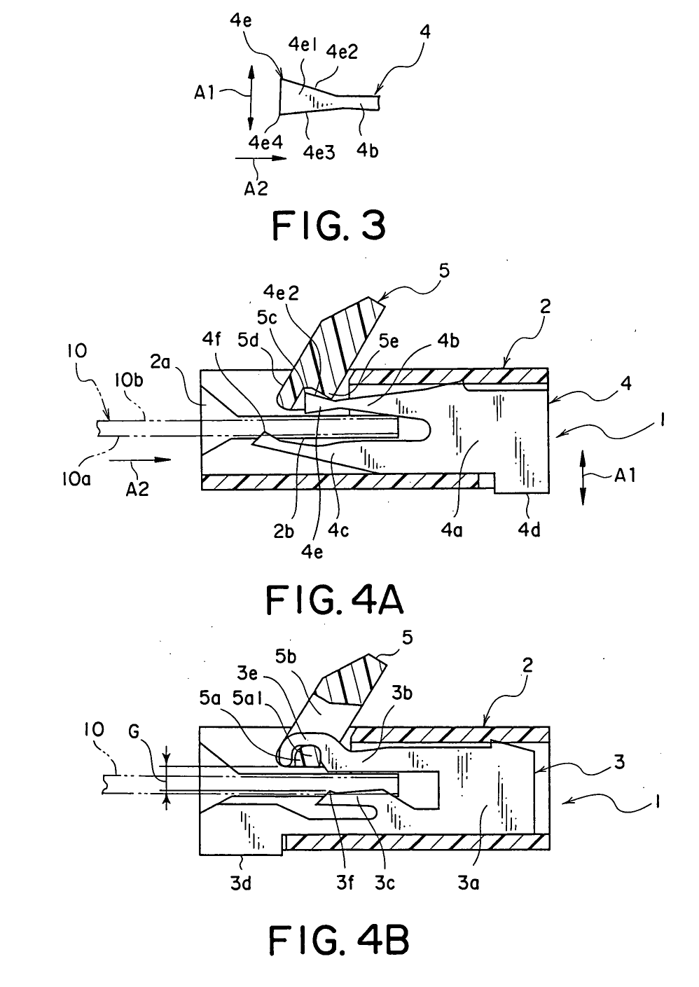

Now, referring to FIGS. 4A, 5A, and 6A in addition to FIG. 3, description will be made of the special shape of the contacting portion 4e. The special shape has a triangular section part 4e1 in which a dimension in the first direction A1 is symmetrically and gradually reduced towards the second direction A2. The triangular section part 4e1 has upper and lower surfaces as slant surfaces 4e2 and 4e3 inclined with respect to the first and the second directions A1 and A2.

In particular, the upper surface of the triangular-section part 4e1, i.e, the slant surface 4e2 is inclined to be gradually closer to the support wall portion 2b towards the second direction A2. As a result, when the actuator 5 is located near the open position as illustrated in FIG. 4A, the slant surface 4e2 is engaged with an edge 5e of the cutout portion 5c to bias the actuator 5 towards the open position.

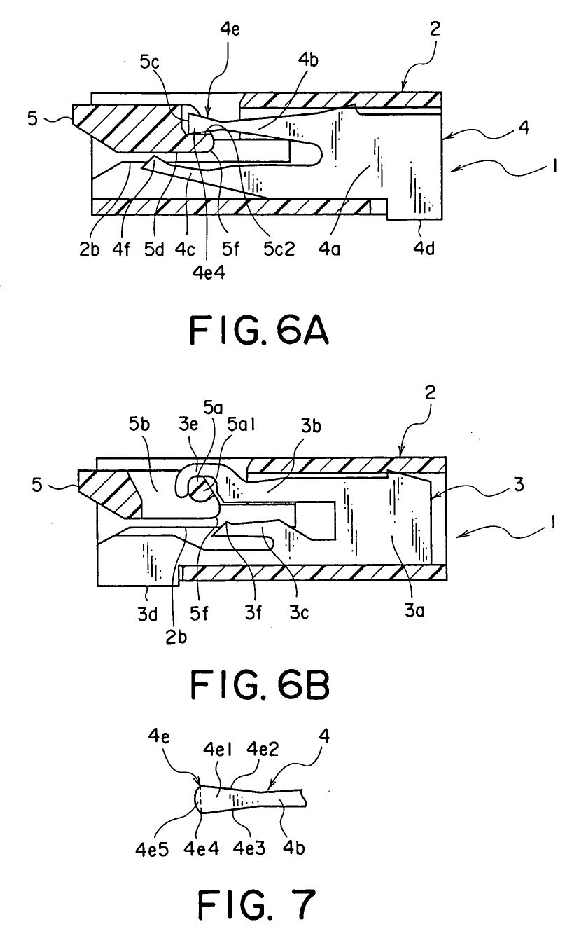

On the other hand, the lower surface of the triangular-section part 4e1, i.e., the slant surface 4e3 forms a protruding portion 4e4 to be engaged with the inner bottom surface of the cutout portion 5c when the actuator 5 is at the closed position as illustrated in FIG. 6A. Therefore, when the actuator 5 is at the closed position, the actuator 5 is prevented by the second contact point 4f and the protruding portion 4e4 from being moved in the first direction A1.

Next referring to FIGS. 4B, 5B, and 6B in addition, description will be made of a method of connecting the connector 1 and the FPC 10.

At first, the FPC 10 has a first surface or a lower surface 10a and a second surface or an upper surface 10b which are faced to each other in the first direction A1. The FPC 10 has a plurality of conductor patterns formed on the lower surface.

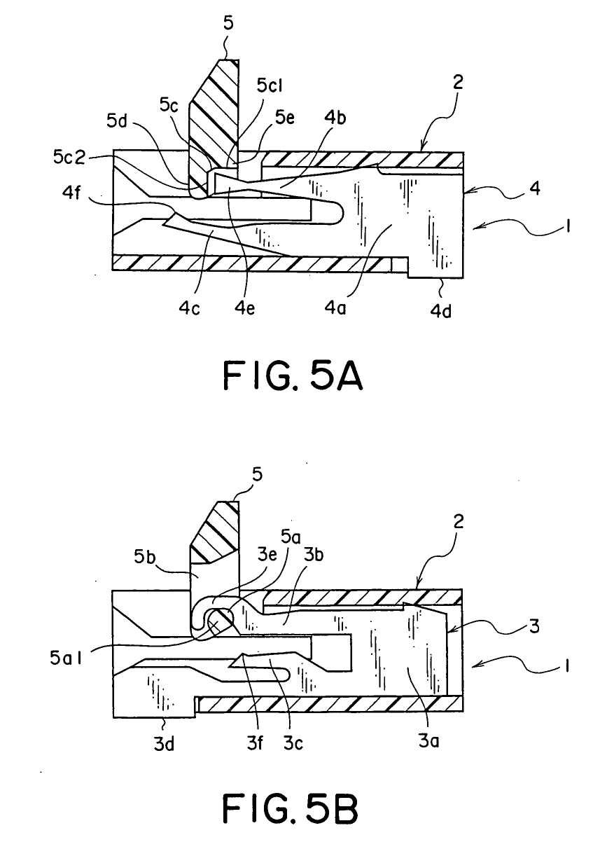

When the actuator 5 is at the open position as shown in FIGS. 4A and 4B, the FPC 10 is inserted to the connector 1. Next, the actuator 5 is rotated counterclockwise. Then, the actuator 5 passes a vertical position in FIGS. 5A and 5B and reaches a horizontal position in FIGS. 6A and 6B, i.e., the closed position. At the closed position, an end portion 5f of the actuator 5 enters into a gap G (see FIG. 4B).

When the actuator 5 is at the closed position, one surface 5c2 of the cutout portion 5c is brought into contact with the protruding portion 4e4 of the contacting portion 4b1. On the other hand, the cam portion 5a is rotatably supported by the engaging portion 3e of the first contact 3 and presses the FPC 10 downward. Therefore, some of the conductor patterns of the FPC 10 are brought into contact with the first contact points 3f of the first contacts 3, respectively. Since the cutout portion 5c is rotatably supported by the contacting portion 4e of the first contact 4, the flat portion 5d of the actuator 5 presses the FPC 10 downward. Therefore, the remaining ones of the conductor patterns of the FPC 10 are brought into contact with the second contact points 4f of the second contacts 4. The lower surface of the FPC 10 is supported by the support wall portion 2b of the housing 2.

Each of the contacting portions 4e of the second contacts 4 has a generally triangular section having a width widened towards its end. At least two surfaces of the contacting portion 4e are flat surfaces. Further, two surfaces 5c1 and 5c2 of each cutout portion 5c of the actuator 5 are flat surfaces. Therefore, the actuator 5 is reliably contacted with the contacting portion 4e at the open position and the closed position and is therefore kept in a stable condition.

As shown in FIG. 7, the special shape of the contacting portion 4e may have an arcuate protruding portion 4e5 of an arc-shaped section integrally formed on an end face of the triangular-section part 4e1 in a direction opposite to the second direction A2. Thus, the contacting portion 4e may have a generally fun-like section. In this case, rotation of the actuator 5 is smoothly carried out.

While the present invention has thus far been described in connection with a few embodiments thereof, it will readily be possible for those skilled in the art to put this invention into practice in various other manners. For example, the actuator may be formed so that its opposite ends are rotatably supported by the housing in addition to supporting by the contacts.

What is claimed is:

1. A connector to be connected to a connection object having first and second surfaces faced to each other in a first direction and inserted in a second direction perpendicular to the first direction, the connector comprising:
a first contact including a first contact point to be contacted with the first surface of the connection object;
a second contact including a second contact point to be contacted with the first surface of the connection object;
a housing to which the first and the second contacts are fixed; and
an actuator faced to the second surface of the connection object and rotatable between a closed position at which the actuator brings the first surface of the connection object into press contact with the first and the second contact points and an open position at which the press contact is released;
the actuator including a cam portion faced to the second surface of the connection object and a cutout portion adjacent to the cam portion;
the first contact further including an engaging portion with a recess which is faced to the second surface of the connection object and engaged with the cam portion and a first beam portion making the engaging portion be elastically held by the housing;
the second contact further including a contacting portion faced to the second surface of the connection object and disposed at the cutout portion and a second beam portion making the contacting portion be elastically held by the housing;
the contacting portion having a special shape such that the contacting portion surrounds the cam portion in cooperation with the recess and biases the actuator towards the open position when the actuator is located near the open position.

2. The connector according to claim 1, wherein the contacting portion has a slant surface to be engaged with an edge of the cutout portion when the actuator is located near the open position.

3. The connector according to claim 2, wherein the slant surface is inclined with respect to the first and the second directions.

4. The connector according to claim 2, wherein the housing has a support wall portion for supporting the first surface of the connection object, the slant surface being inclined to be gradually closer to the support wall portion towards the second direction.

5. The connector according to claim 1, wherein the contacting portion has a protruding portion to be engaged with an inner surface of the cutout portion when the actuator is at the closed position.

6. The connector according to claim 5, wherein the actuator is prevented by the second contact point and the protruding portion from being moved in the first direction and prevented by the recess from being moved in the second direction when the actuator is at the closed position.

7. The connector according to claim 1, wherein the special shape has a triangular-section part in which a dimension in the first direction is symmetrically and gradually reduced towards the second direction.

8. The connector according to claim 7, wherein the special shape has an arcuate protruding portion of an arc-shaped section formed on an end face of the triangular-section part in a direction opposite to the second direction.

9. The connector according to claim 1, wherein the cam portion has a shaft portion having a generally semicircular section and serving as a rotation shaft of the actuator.

10. The connector according to claim 9, wherein the recess has a shape such that the recess is fitted over the shaft portion to allow rotation of the shaft portion.
